(19) United States
(12) Patent Application Publication
(10) Pub. No.: US 2018/0180558 A1
(43) Pub. Date: Jun. 28, 2018

(54) X-RAY PHASE IMAGING APPARATUS

(71) Applicant: Shimadzu Corporation, Kyoto (JP)

(72) Inventors: Satoshi SANO, Uji (JP); Taro SHIRAI, Osaka (JP); Takahiro DOKI, Kizugawa (JP); Akira HORIBA, Uji (JP)

(21) Appl. No.: 15/717,191

(22) Filed: Sep. 27, 2017

(30) Foreign Application Priority Data
Dec. 26, 2016 (JP) 2016-251680

(51) Int. Cl. G01N 23/04

(52) U.S. Cl. CPC G01N 23/04; G21K 1/067

(57) ABSTRACT

This X-ray phase imaging apparatus includes an X-ray source, a detector, a plurality of gratings including a phase grating and an absorption grating, and an image processing unit for generating an image including a dark field image. The image processing unit generates an image including a dark field image from an image captured by placing the plurality of gratings at one or two predetermined positions.

### CROSS-REFERENCE TO THE RELATED APPLICATIONS

The present application claims priority to Japanese Patent Application No. 2016-251680, entitled “X-ray Phase Imaging Apparatus”, filed on Dec. 26, 2016, and invented by Satoshi Sano, Taro Shirai, Takahiro Doki, and Akira Horiba, upon which this patent application is based is hereby incorporated by reference in its entirety.

### BACKGROUND OF THE INVENTION

### Field of the Invention

The present invention relates to an X-ray phase imaging apparatus, and more particularly to an X-ray phase imaging apparatus configured to obtain an X-ray phase contrast image by a method (fringe scanning method) of generating a reconstruction image from a plurality of images obtained by scanning a grating at regular periodic intervals.

### Background Art

Conventionally, an X-ray phase imaging apparatus is known in which an X-ray phase contrast image is obtained by a method (fringe scanning method) of generating a reconstruction image from a plurality of images obtained by scanning a grating at regular periodic intervals. Such an X-ray phase imaging apparatus is disclosed in, for example, Japanese Unexamined Patent Application No. 2012-16370 (hereby incorporated by reference).

In Japanese Unexamined Patent Application Publication No. 2012-16370, an X-ray phase imaging apparatus is disclosed in which an X-ray phase contrast image is obtained from nine images obtained by translating a grating in the periodic direction by 1/9 period. An absorption image, a phase differential image, and a dark field image are included in the X-ray phase contrast image.

However, the conventional X-ray phase imaging apparatus as described in Japanese Unexamined Patent Application Publication No. 2012-16370 has a problem that an X-ray phase contrast image including a dark field image is generated from nine images captured by scanning the grating nine times, and therefore it takes time to capture an image. Further, in the case of using a medical use, there is a problem that the exposure dose of the X-ray increases when imaging is performed many times.

The present invention has been made in view of the aforementioned problems, and one object of the present invention is to provide an X-ray phase imaging apparatus capable of shortening an exposure time for imaging an object and reducing an exposure dose of X-rays.

### SUMMARY OF THE INVENTION

Various embodiments disclosed herein are directed to decreasing an amount of amplitude of a detected X-ray intensity-modulated signal (e.g., a waveform representing the change in pixel value detected by the detector), such as in the case in which there exists an object and in the case in which there exist no object in order to obtain a dark field image of the object. An X-ray phase imaging apparatus according to one embodiment of the present invention includes an X-ray source, a detector configured to detect an X-ray irradiated from the X-ray source, a plurality of gratings including a first grating to which the X-ray from the X-ray source is irradiated and a second grating to which the X-ray that passed through the first grating is irradiated, the first grating the second grating being arranged between the X-ray source and the detector, and an image processing unit configured to generate an image including a dark field image from an intensity distribution of the X-ray detected by the detector, wherein the image processing unit is configured to generate the image including the dark field image from an image captured by placing the plurality of gratings at one or two predetermined positions.

Here, in cases where there exists a microstructure such as a crack in the object, the X-ray is scattered in various directions due to the microstructure in the object, and the visibility (interference fringe sharpness) of the X-ray that passes through the object changes. That is, comparing the case in which there exists an object with the case in which there exists no object, in the case in which there exists an object, the amplitude of the intensity-modulated signal of the obtained X-ray decreases. The intensity-modulated signal described here is a signal representing a change in a pixel value detected by the detector when scanning the second grating by one period. Since the amplitude of the intensity-modulated signal decreases also by the absorption of the X-ray by the object, when the decreased amount of the amplitude of the intensity-modulated signal is obtained from the image captured by placing the plurality of gratings at one predetermined position, an image including an absorption component and a dark field component can be generated. Further, when the decreased amount of in the amplitude of the intensity-modulated signal is obtained from the image captured by placing the plurality of gratings at two predetermined positions, the absorption component and the dark field component can be individually extracted. Therefore, the absorption image and the dark field image can be generated. Therefore, in the X-ray phase imaging apparatus according to one aspect of the present invention, as described above, it is possible to generate an image including a dark field image from an image captured by placing a plurality of gratings at one or two predetermined positions. As a result, it becomes possible to suppress the number of times that imaging is performed by moving (scanning) a grating in the periodic direction of the grating, which can shorten the exposure time at the time of imaging the object and reduce the exposure amount of the X-ray.

In the X-ray phase imaging apparatus according to the certain embodiments of the present invention, it is preferably configured such that the image processing unit generates the dark field image from images captured at two positions of a first relative position and a second relative position in which either one grating among the plurality of gratings is moved in a periodic direction of the grating. By configuring as described above, by capturing an image at predetermined position where gratings are placed at two specified positions, the absorption component can be extracted from the sum of the intensities of the X-rays obtained at two specified positions, and the dark field component can be extracted from the intensity difference of the X-rays obtained at two positions. Only the dark field image can be generated by removing the absorption component from the dark field component. Further, when generating a dark field image, it is sufficient to capture an image by placing gratings at two positions of a first relative position and a second relative position. Therefore, compared with the case using a conventional fringe scanning method, it is possible to reduce the number of times that an image is captured by moving (scanning) the grating to the periodic direction of the grating. As a result, the exposure time can be shortened and the exposure dose of the X-ray can be reduced.

In this case, it is preferable to configure such that the image processing unit generates the dark field image from a first image captured at the first relative position where the first grating and the second grating are arranged so that a center of a bright line of a self-image of the first grating is located at a slit portion of the second grating, and a second image captured at the second relative position where the first grating and the second grating are arranged so that the center of the bright line of the self-image of the first grating is located in an X-ray absorption portion of the second grating, by configuring as described above, the intensity of the X-ray detected at the first relative position corresponds to the peak portion of the waveform obtained as the intensity-modulated signal, and the intensity of the X-ray detected at the second relative position corresponds to the valley part of the waveform. For this reason, as compared with the case in which the comparison is made at two peak portions or valley portions of the waveform, the intensity difference of the obtained X-ray becomes larger and the way of decreasing the amplitude of the intensity-modulated signal in cases where there exists an object becomes clear. As a result, the accuracy of the generated dark field image to be generated can be improved.

It may be more preferable to configure such that the image processing unit generates a dark field image from the first image captured at the first relative position where the first grating and the second grating are arranged such that the center of the bright line of the self-image of the first grating substantially coincides with the center of the slit portion of the second grating, and the second image captured at the second relative position where the first grating and the second grating are arranged such that the center of the bright line of the self-image of the first grating substantially coincides with the center of the X-ray absorption portion of the second grating. In certain implementations, it is possible to detect the X-ray of the portion corresponding to the vertex of the amplitude of the intensity-modulated signal (the waveform representing the change in the pixel value detected by the detector) obtained by detecting the X-ray. In other words, since the X-ray of the portion which most contributes to contrast generation can be detected, the intensity difference of the obtained X-ray becomes maximum, and the way of decreasing the amplitude of the intensity-modulated signal in the case in which there exists an object becomes more clear. As a result, the accuracy of the generated dark field image to be generated can be further improved.

In the configuration in which the dark field image is generated from the image captured by arranging the plurality of gratings at two predetermined positions, it is preferably configured to further include a rotation mechanism for relatively rotating the object and the imaging system equipped with an X-ray source, a plurality of gratings and a detector, in each of the plurality of rotation positions accompanying the relative rotation between the object and the imaging system, tomographic imaging is performed by capturing an image by placing a plurality of gratings at the first relative position and the second relative position. By configuring as described above, in each rotation position, it becomes possible to perform CT imaging (tomography) by the image captured by placing the gratings at two positions. As a result, compared with the case in which CT imaging (tomography) is performed using a normal fringe scanning method, it becomes possible to reduce the number of times that an image is captured by moving (scanning) the grating in the periodic direction of the grating, so that the exposure time can be shortened.

In the configuration in which a dark field image is generated from the image captured by arranging the plurality of gratings at two predetermined positions, it is preferably configured to further include a rotation mechanism configured to relatively rotate an object and an imaging system including an X-ray source, a plurality of gratings, and a detector, and the image processing unit performs tomographic imaging, in each of a plurality of rotation positions accompanying the relative rotation of one rotation of the object and the imaging system, by capturing an image by placing the plurality of gratings in either the first relative position or the second relative position in a range of 180 degrees in a first half, or by capturing an image by placing a plurality of gratings in either the first relative position or the second relative position in a range of 180 degrees in a second half. By configuring as described above, in each rotation position, during imaging within the range of 180 degrees in the first half and during imaging within the range of 180 degrees in the second half, CT imaging (tomography) can be performed without moving (scanning) the grating in the periodic direction of the grating. As a result, compared with CT imaging (tomography) using a normal fringe scanning method, it becomes possible to further reduce the number of times that an image is captured by moving (scanning) the grating in the periodic direction of the grating, so that the exposure time can be further shortened.

In the X-ray phase imaging apparatus according to some embodiments the present invention, it is preferably configured such that the image processing unit generates a third image including an absorption image and the dark field image from an image captured by placing the plurality of gratings at one predetermined position. By configuring as described above, the difference of the X-ray intensities obtained in the case in which there exists an object and in the case in which there exists no object from an image captured by placing a grating at a predetermined one position. In other words, the reduced amount of the amplitude of the X-ray intensity-modulated signal (the waveform representing the change of the pixel value detected by the detector) in the case in which there exists an object and in the case in which there exists no object can be found. With this, it is possible to generate an image including an absorption image and a dark field image from the ratio of X-ray intensities in the case in which there exists an object and in the case in which there exists no object, which eliminates the necessity of moving (scanning) the grating in the periodic direction of the grating during imaging. As a result, the exposure time can be further shortened and the X-ray exposure dose can be further reduced.

In certain cases, it is preferably configured such that the image processing unit generates the third image from either one of images of the first image captured by placing the first grating and the second grating so that a center of a bright line of the self-image of the first grating is positioned at the slit portion of the second grating, and the second image captured by placing the first grating and the second grating so that the center of the bright line of the self-image of the first grating is placed at the X-ray absorption portion of the second grating. By configuring as described above, the intensity of the X-ray detected at the predetermined position corresponds to the peak portion or the valley portion of the waveform obtained as the intensity-modulated signal. Therefore, the amount of change in the amplitude of the intensity-modulated signal increases between the case in which there exists an object and the case in which there exists no object, and the decreased amount of the amplitude of the intensity-modulated signal becomes clear. As a result, the accuracy of the generated image can be improved.

It may be more preferable to configure such that the image processing unit generates a third image from either one of images of the first image captured by placing the first grating and the second grating so that the center of the bright line of the self-image of the first grating substantially coincides with the center of the slit portion of the second grating, and the second image captured by placing the first grating and the second grating so that the center of the bright line of the self-image of the first grating substantially coincides with the center of the X-ray absorption portion of the second grating. In certain embodiments, it is possible to detect the X-ray of the portion corresponding to the vertex of the amplitude of the intensity-modulated signal obtained by detecting the X-ray. That is, since it is possible to detect the X-ray of the portion that most contributes to a contrast generation, the amount of change in the amplitude of the intensity-modulated signal between the case in which there exists an object and in the case in which there exists no object becomes maximum, and the way of decreasing the amplitude of the intensity-modulated signal in the case in which there exists an object becomes more clear. As a result, the accuracy of the image to be generated can be further improved.

In the X-ray phase imaging apparatus according to certain embodiments of present invention, the plurality of gratings further includes a third grating placed between the X-ray source and the first grating. By configuring as described above, due to the third grating, the coherence of the X-ray irradiated from the X-ray source can be enhanced. As a result, it is possible to generate an image including a dark field image using an X-ray source in which the focal length is not very small.

### BRIEF DESCRIPTION OF THE DRAWINGS

FIG. 1 is a diagram showing an overall configuration of an X-ray phase imaging apparatus according to a first embodiment of the present invention.

FIG. 2 is a flowchart showing an X-ray phase contrast image generation process flow according to the first embodiment of the present invention.

FIG. 3 shows image diagrams (A) to (D) showing a positional relationship between the bright line of the self-image of the first grating and the second grating according to the first embodiment of the present invention.

FIG. 4 shows image diagrams (A) to (D) showing a positional relationship between the waveform of the self-image and the second grating according to the first embodiment of the present invention.

FIG. 5 is an image diagram of a sine wave showing the intensities of the X-rays obtained in the case in which there exists an object and the case in which there exists no object of the first embodiment of the present invention.

FIG. 6 shows image diagrams (A) to (D) of an image obtained at the first relative position and the second relative position according to the first embodiment of the present invention, and image views of the absorption image (E) and the dark field image (F) generated at the image processing unit.

FIG. 7 is a diagram showing an overall configuration of an X-ray phase imaging apparatus according to a second embodiment of the present invention.

FIG. 8 shows image views (A) and (B) of images obtained at predetermined positions of the third embodiment of the present invention and an image view of an image (C) including an absorption image and a dark field image generated by the image processing unit.

FIG. 9 is a diagram showing an overall configuration of an X-ray phase imaging apparatus according to a fourth embodiment of the present invention.

### DESCRIPTION OF PREFERRED EMBODIMENTS

Hereinafter, embodiments of the present invention will be described with reference to the drawings, in which various exemplary embodiments are shown. The invention may, however, be embodied in many different forms and should not be construed as limited to the exemplary embodiments set forth herein. These example exemplary embodiments are just that—examples—and many embodiments and variations are possible that do not require the details provided herein. It should also be emphasized that the disclosure provides details of alternative examples, but such listing of alternatives is not exhaustive. Furthermore, any consistency of detail between various exemplary embodiments should not be interpreted as requiring such detail—it is impracticable to list every possible variation for every feature described herein. The language of the claims should be referenced in determining the requirements of the invention.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

The embodiments are described, and illustrated in the drawings, in terms of functional blocks, units and/or modules. These blocks, units and/or modules may be physically implemented by electronic (or optical) circuits such as logic circuits, discrete components, microprocessors, hard-wired circuits, memory elements, wiring connections, and the like, which may be formed together in a single integrated circuit (e.g., as a single semiconductor chip) or as separate integrated circuits and/or discrete components (e.g., several semiconductor chips wired together on a printed circuit board) using semiconductor fabrication techniques and/or other manufacturing technologies. These blocks, units and/or modules may be implemented by a processor (e.g., a microprocessor, a controller, a CPU, a GPU) or processors that are programmed using software (e.g., microcode) to perform various functions discussed herein. Each block, unit and/or module may be implemented by dedicated hardware, or as a combination of dedicated hardware to perform some functions and a processor to perform other functions. Also, each block, unit and/or module of the embodiments may be embodied by physically separate circuits and need not be formed as a single integrated circuit.

### First Embodiment

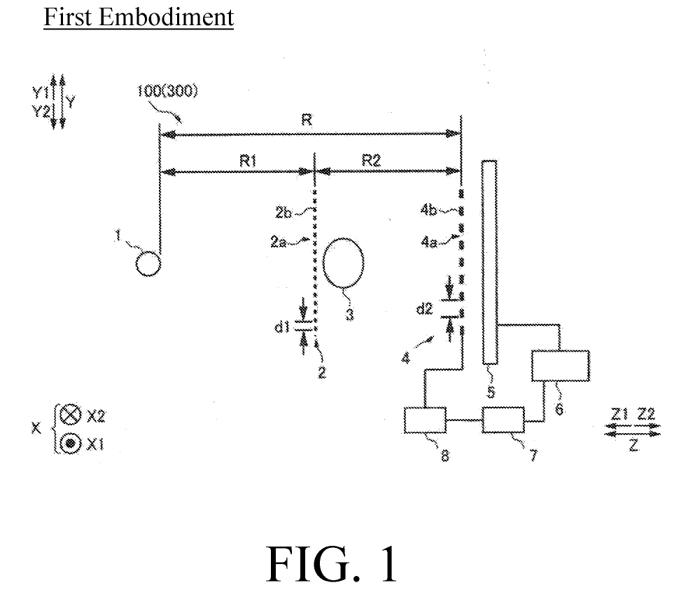

A configuration of an X-ray phase imaging apparatus 100 according to a first embodiment of the present invention will be described with reference to FIGS. 1 to 6.

### (Configuration of X-ray Phase Imaging Apparatus)

A configuration of the X-ray phase imaging apparatus 100 according to the first embodiment of the present invention will be described with reference to FIG. 1.

As shown in FIG. 1, the X-ray phase imaging apparatus 100 is equipped with an X-ray source 1, a phase grating 2, an absorption grating 4, a detector 5, an image processing unit 6, a control unit 7, and a grating moving mechanism 8. In this specification, the direction from the X-ray source 1 to the phase grating 2 is referred to as a Z2 direction, and the opposite direction is referred to as a Z1 direction. The right and left direction in a plane orthogonal to the Z direction is referred to as an X direction, the direction toward the rear side of the paper is referred to as an X2 direction, and the direction toward the front side of the paper is referred to as an X1 direction. Further, the up and down direction in the plane orthogonal to the Z direction is referred to as a Y direction, the upward direction is referred to as a Y1 direction, and the downward direction is referred to as a Y2 direction. The phase grating 2 and the absorption grating 4 are an example of the “first grating” and an example of the “second grating” recited in claims, respectively.

The X-ray source 1 is configured to generate an X-ray and irradiate the generated X-ray when a high voltage is applied.

The phase grating 2 includes a plurality of slits 2a arranged at a predetermined period (pitch) d1 in the Y direction and an X-ray phase change portion 2b. The slits 2a and the X-ray phase change portion 2b are each formed so as to extend in the X direction.

The phase grating 2 is arranged between the X-ray source 1 and the absorption grating 4, so that an X-ray is irradiated to the phase grating 2. The phase grating 2 is provided to form a self-image by a Talbot effect. When an X-ray having coherence passes through a grating in which slits are formed, a grating image (self-image) is formed at a position away from the grating by a predetermined distance (Talbot distance). This is called a Talbot effect. A self-image is an interference fringe caused by X-ray interference.

The absorption grating 4 has a plurality of slits 4a and X-ray absorber 4b arranged at a predetermined period (pitch) d2 in the Y direction. The slits 4a and the X-ray absorber 4b are each formed so as to extend in the X direction. The absorption grating 4 is arranged between the phase grating 2 and the detector 5, and an X-ray that passed through the phase grating 2 is irradiated to the absorption grating 4. Further, the absorption grating 4 is arranged at a position away from the phase grating 2 by the Talbot distance.

When the distance between the X-ray source 1 and the phase grating 2 is R1, the distance between the phase grating 2 and the absorption grating 4 is R2, and the distance between the X-ray source 1 and the absorption grating 4 is R (=R1+R2), the positional relationship between the X-ray source 1, the phase grating 2, and the absorption grating 4 is expressed by the following expression (1).

R₁/R=d₁/d₂ (1)

The detector 5 is configured to detect an X-ray, convert the detected X-ray into an electric signal, and read the converted electric signal as an image signal. The detector 5 is, for example, an FPD (Flat Panel Detector). The detector 5 is composed of a plurality of conversion elements (not shown) and a plurality of pixel electrodes (not shown) arranged on the plurality of conversion elements. A plurality of conversion elements and pixel electrodes are arranged side by side in the X direction and the Y direction at a predetermined period (pixel pitch).

The detection signal of the detector 5 is sent to the image processing unit 6. The image processing unit 6 is configured to generate an image including a dark field image from an image captured by placing the phase grating 2 and the absorption grating 4 at one or two predetermined positions.

The control unit 7 is configured to generate an image including the dark field image using the image processing unit 6. Further, the control unit 7 is configured to move the absorption grating 4 to a predetermined position using the grating moving mechanism 8.

The grating moving mechanism 8 is provided with a grating gripping portion (not shown) for gripping the absorption grating 4 and a grating moving stage (not shown) for moving the gripped grating in the Z direction and the Y direction. The grating moving mechanism 8 is configured to move the absorption grating 4 gripped by the grating gripping portion in predetermined directions of the Z direction and the Y direction based on the signal sent from the control unit 7.

### (X-Ray Phase Contrast Image Generation Method by Conventional Fringe Scanning Method)

Here, a method for generating an absorption image and a dark field image in a conventional fringe scanning method will be described. In a conventional fringe scanning method, an X-ray phase contrast image is generated from images captured by translating the grating in the periodic direction of the grating by the 1/M period. For example, when fringe scanning of M steps are performed, the intensity Iₖ (x, y) of the X-ray in each step k is expressed by the following expression (2).

$${I}_{k} ( x , y ) = {\sum }_{n} {a}_{n} exp ( - 2 i π n ( \frac{{z}_{0}}{{d}_{1}} {ϕ}_{x} ( x , y ) + \frac{k}{M} ) ) \qquad ( 2 )$$

Here, aₙ is an amount of each frequency component of the interference fringe. Z₀ is a distance between the phase grating 2 and the absorption grating 4. d₁ is a period (pitch) d1 of the phase grating 2. x and y are coordinate positions in the plane orthogonal to the irradiation axis of the X-ray on the detection surface of the detector 5.

When the intensity in cases where an object 3 is placed is Iₖ (x, y) and the intensity in cases where an object 3 is placed is I₀ₖ(x, y), S(x, y) and S₀ (x, y) are defined as in the following expressions (3) and (4).

$$\begin{matrix}S ( x , y ) = {\sum }_{k = 1}^{M} {I}_{k} ( x , y ) exp ( - \frac{2 i π k}{M} ) & ( 3 ) \\ {S}_{0} ( x , y ) = {\sum }_{k = 1}^{M} {I}_{0 k} ( x , y ) exp ( - \frac{2 i π k}{M} ) & ( 4 )\end{matrix}$$

The absorption image T(x, y) is expressed by the following expression (5).

$$T ( x , y ) = \frac{{\sum }_{k = 1}^{M} {I}_{k} ( x , y )}{{\sum }_{k = 1}^{M} {I}_{0 k} ( x , y )} \qquad ( 5 )$$

Further, visibility in cases where an object 3 is placed is V(x, y), and visibility in cases where an object 3 is not placed is V₀(x, y), V(x, y) and V₀ (x, y) are expressed by the following expressions (6) and (7).

$$\begin{matrix}V ( x , y ) = \frac{2 \vert S ( x , y ) \vert}{{\sum }_{k = 1}^{M} {I}_{k} ( x , y )} & ( 6 ) \\ {V}_{0} ( x , y ) = \frac{2 \vert {S}_{0} ( x , y ) \vert}{{\sum }_{k = 1}^{M} {I}_{0 k} ( x , y )} & ( 7 )\end{matrix}$$

The dark field image D(x, y) is expressed by the following expression (8).

$$D ( x , y ) = \frac{V ( x , y )}{{V}_{0} ( x , y )} = \frac{\vert S ( x , y ) \vert}{\vert {S}_{0} ( x , y ) \vert} / T ( x , y ) \qquad ( 8 )$$

### (X-Ray Phase Contrast Image Generation Method)

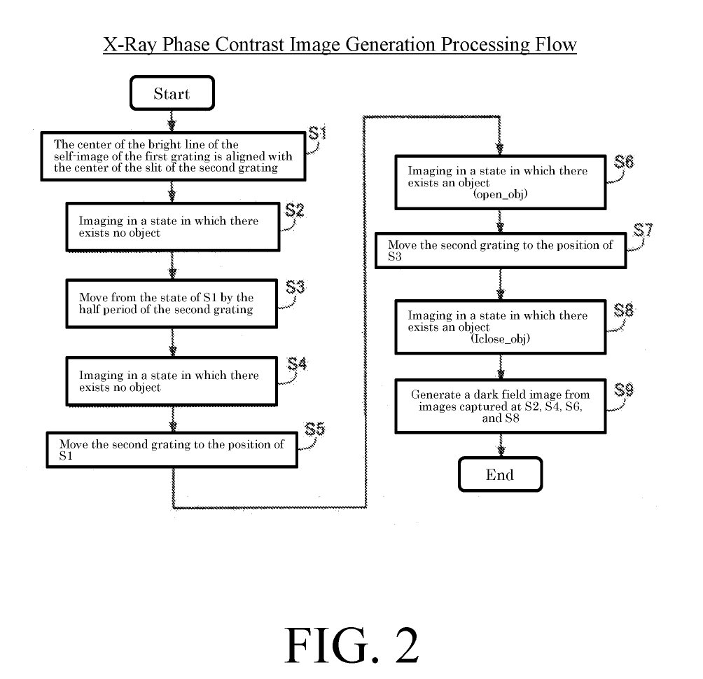

Next, a method of generating an X-ray phase contrast image of the X-ray phase imaging apparatus 100 according to the first embodiment of the present invention will be described with reference to FIGS. 2 to 6.

First, referring to FIG. 2, the X-ray contrast image generation processing in the X-ray phase imaging apparatus 100 will be described based on the flowchart.

In Step S1, the control unit 7 moves the phase grating 2 and the absorption grating 4 via the grating moving mechanism 8 so that the center of the bright line 2c of the self-image of the phase grating 2 substantially coincides with the center of the slit 4a of the absorption grating 4 to align the phase grating 2 and the absorption grating 4. In this specification, a state in which the phase grating 2 and the absorption grating 4 are arranged at the position aligned in Step S1 is defined as “opened illumination”.

Then, in Step S2, imaging is performed without placing the object 3. In Step S3, the control unit 7 moves the absorption grating 4 in the Y direction (in the periodic direction of the grating) by a half period of the period d2 of the absorption grating 4 via the grating moving mechanism 8. A state in which the phase grating 2 and the absorption grating 4 are arranged at the position aligned in Step S3 is defined as “closed illumination”. Then, in Step S4, imaging is performed without placing the object 3.

Then, in Step S5, the control unit 7 moves the absorption grating 4 in the Y direction (in the periodic direction of the grating) to the position (opened illumination) at which the positioning was performed in Step S1 via the grating moving mechanism 8. Then, in Step S6, imaging is performed with the object 3 fixedly placed.

Then, in Step S7, the control unit 7 moves the absorption grating 4 in the Y direction (in the periodic direction of the grating) to the position (opened illumination) at which the positioning was performed in Step S3 via the grating moving mechanism 8. Then, in Step S8, imaging is performed with the object 3 fixedly placed.

In Step S9, an image including a dark field image is generated from the images captured in Steps S2, S4, S6, and S8. In this specification, the images captured in Steps S2, S4, S6, and S8 are defined as “Iₒₚₑₙ_{_}ₐᵢᵣ”, “I_{close}_{_}ₐᵢᵣ”, “Iₒₚₑₙ_{_}_{obj}”, and “I_{close}_{_}_{obj}”, respectively. Iₒₚₑₙ_{_}ₐᵢᵣ and Iₒₚₑₙ_{_}_{obj} are examples of the “first image” recited in claims. I_{close}_{_}ₐᵢᵣ and I_{close}_{_}_{obj} are examples of the “second image” recited in claims. The opened illumination and the closed illumination are examples of the “first relative position” and the “second relative position” recited in claims.

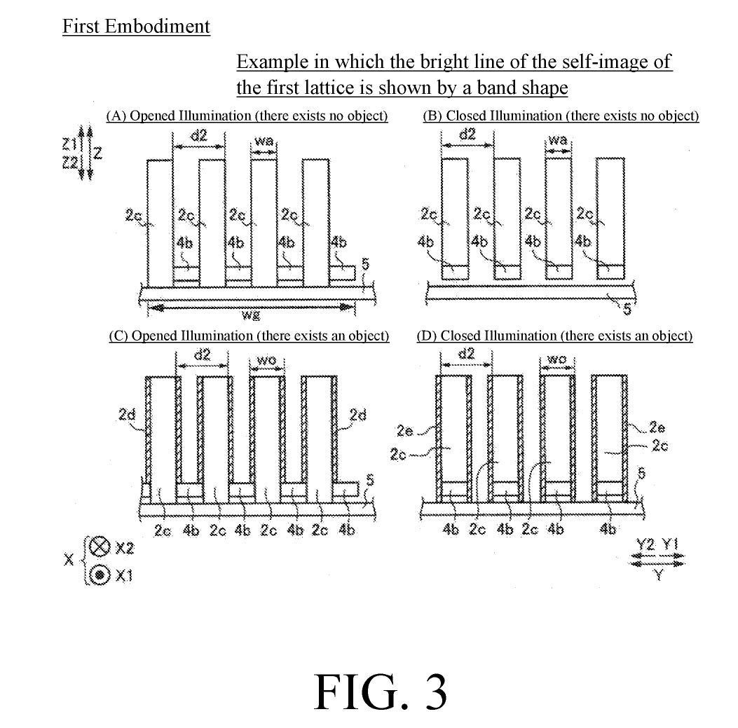

FIG. 3 is an image diagram showing a bright line 2c of a self-image of a phase grating 2 in a band shape. The self-image of the phase grating 2 is formed by the bright line 2c portion and the dark line portion between the bright lines 2c, and is observed on the absorption grating 4. (A) and (B) in FIG. 3 show the positional relationship between the bright line 2c of the self-image of the phase grating 2 and the X-ray absorber 4b of the absorption grating 4 in the state of the opened illumination and the state of the closed illumination when the object 3 is not placed. (C) and (D) in FIG. 3 show the positional relationship between the bright line 2c of the self-image of the phase grating 2 and the X-ray absorber 4b of the absorption grating 4 in the state of the opened illumination and the state of the closed illumination when the object 3 is placed. In this specification, the bright line of the self-image of the phase grating 2 denotes the bright line 2c, and the center of the bright line of the self-image of the phase grating 2 denotes the center of the bright line 2c.

In the first embodiment, when it is assumed that the X-ray absorber 4b of the absorption grating 4 is an ideal substance which does not transmit an X-ray at all, as shown in (A) in FIG. 3, X-ray (the bright line 2c of the self-image of the phase grating 2) passes through the slit 4a of the absorption grating 4 in the state of the opened illumination in the case in which the object 3 is not arranged. Therefore, in the detector 5, all X-rays of the bright line 2c are detected. Further, as shown in (B) in FIG. 3, in the state of the closed illumination in the case in which the object 3 is not placed, the X-ray of the bright line 2c is all absorbed by the X-ray absorber 4b of the absorption grating 4, so the X-ray is not detected by the detector 5.

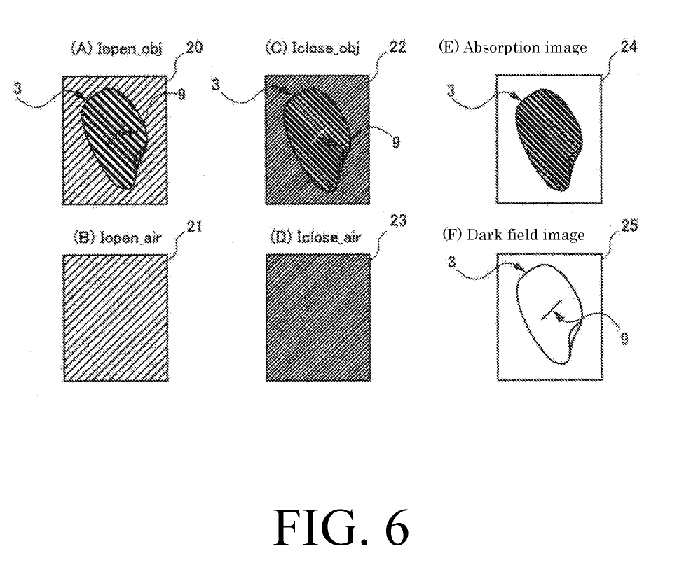

Next, when arranging the object 3, the X-ray radiated from the phase grating 2 is partly scattered by, for example, cracks 9 (see FIG. 6) inside the object 3. As a result, the width of the bright line 2c of the self-image of the phase grating 2 diffuses from the width wa to the width wo. As shown in (C) in FIG. 3, since the bright line 2c of the self-image of the phase grating 2 has changed from the width wa to the width wo, the bright line portion 2d absorbed by the X-ray absorber 4b appears. Therefore, the intensity of the X-ray of the bright line 2c detected by the detector 5 decreases as compared with the case in which the object 3 is not placed. For example, it is assumed that the width wa of the bright line 2c of the self-image of the phase grating 2 in the case in which the object 3 is not placed is 5 μm, the period d2 of the absorption grating 4 is 10 μm, the size wg of 1 pixel of the detector 5 is set to 40 μm, and the width wo of the bright line 2c of the self-image of the phase grating 2 is diffused to 7 μm by the internal crack 9 of the object 3, the intensity of the X-ray of the bright line 2c detected by the detector 5 decreases to 5/7 when the intensity in the state of (A) in FIG. 3 is 1.

As shown in (D) of FIG. 3, also in the closed illumination, since the width of the bright line 2c of the self-image of the phase grating 2 is diffused from the width wa to the width wo by the object 3, the X-ray is not absorbed by the X-ray absorber 4b, and a bright line portion 2e passing through the slit 4a appears. Therefore, the intensity of the X-ray of the bright line 2c detected by the detector 5 increases as compared with the case in which the object 3 is not placed. For example, in the same manner as in the opened illumination, when the width wo of the bright line 2c of the self-image of the phase grating 2 is diffused to 7 μm by the cracks 9 inside the object 3, the intensity of the X-ray of the bright line 2c of the self-image of the phase grating 2 detected by the detector 5 increases to 2/7, assuming that the intensity of the state of (B) in FIG. 3 is 1.

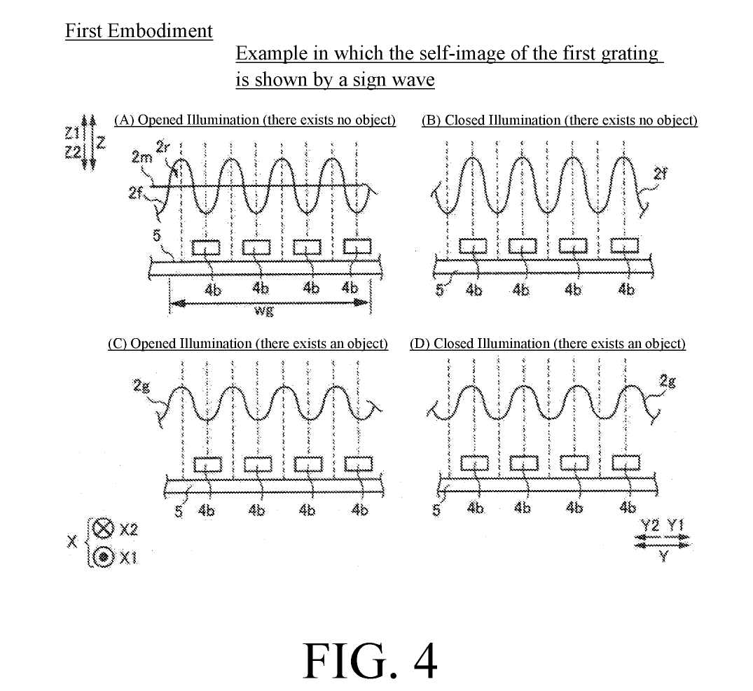

FIG. 4 is an image diagram showing the self-image of the phase grating 2 in a waveform form. (A) and (B) in FIG. 4 show the positional relationship between the waveform 2f of the self-image of the phase grating 2 and the X-ray absorber 4b of the absorption grating 4 in the state of the opened illumination and the state of the closed illumination in the case in which the object 3 is not placed. (C) and (D) in FIG. 4 show the positional relationship between the waveform 2g of the self-image of the phase grating 2 and the X-ray absorber 4b of the absorption grating 4 in the state of the opened illumination and the state of the closed illumination in the case in which the object 3 is placed. In the present specification, the bright line of the self-image of the phase grating 2 denotes the line 2m showing the average value of the total amplitude of the waveform 2f and the area 2r formed by the portion of the waveform 2f above the straight line 2m, and the center of the bright line of the phase grating 2 denotes the center of the area 2r.

Due to the diffusion of the X-ray by the internal cracks 9 of the object 3, the waveform 2f of the self-image of the phase grating 2 in the case in which the object 3 is not placed changes to the waveform 2g of the self-image of the phase grating 2 in the case in which the object 3 is placed. That is, since the amplitude of the waveform 2f of the self-image of the phase grating 2 decreases and becomes the waveform 2g, in the opened illumination state, the rate of the X-ray absorbed by the X-ray absorber 4b of the absorption grating 4 increases, and in the closed illumination state, the X-ray passing through the slit 4a of the absorption grating 4 increases. Therefore, in the opened illumination state, the intensity of the X-ray detected by the detector 5 decreases, and in the closed illumination state, the intensity of the X-ray detected by the detector 5 increases.

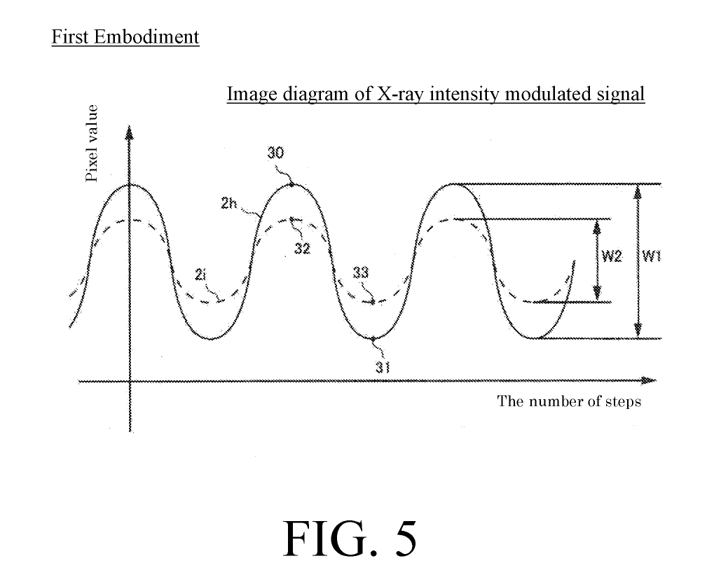

Here, the dark field image is an image obtained by imaging the change in the X-ray intensity (pixel value) obtained by the diffusion of the X-ray caused by multiple scattering of the X-ray due to the fine structure such as scratches existing inside the object at the time when the X-ray passes through the object by calculation. Therefore, in order to generate the dark field image, it is sufficient to know the decreased amount (how to collapse) of the intensity-modulated signal of the X-ray (a waveform representing the change of the pixel value detected by the detector) detected in the case in which the object 3 is placed and the case in which the object is not place. That is, the image processing unit 6 determines the decreased amount of the amplitude of the intensity-modulated signal from the amplitude W1 of the waveform 2h of the intensity-modulated signal of the X-ray in the case in which the object 3 shown in FIG. 5 is not placed and the amplitude W2 of the waveform 2i of the intensity-modulated signal of the X-ray in the case in which the object 3 is placed to generate a dark field image.

Specifically, in order to obtain the decreased amount of the amplitude of the intensity-modulated signal, the decreased amount can be obtained from two X-ray intensities (pixel values) having different X-ray intensities to be detected. That is, the amplitude W1 of the waveform 2h is calculated by the difference between the intensity (pixel value) 30 of the X-ray detected in the state of the opened illumination when the object 3 is not placed and the intensity (pixel value) 31 of the X-ray detected in the state of the closed illumination. That is, the amplitude W2 of the waveform 2i is calculated by the difference between the intensity (pixel value) 32 of the X-ray detected in the state of the opened illumination in the case in which the object 3 is not placed and the intensity (pixel value) 33 of the X-ray detected in the state of the closed illumination. The absorption image and the dark field image can be generated from the X-ray intensities at these two positions by the following expressions (9) and (10). x and y are coordinate positions in the plane orthogonal to the irradiation axis direction of the X-ray on the detection surface of the detector 5.

$$\begin{matrix}T ( x , y ) = \frac{{I}_{open\_obj} ( x , y ) + {I}_{close\_obj} ( x , y )}{{I}_{open\_air} ( x , y ) + {I}_{close\_air} ( x , y )} & ( 9 ) \\ D ( x , y ) = \frac{{I}_{open\_obj} ( x , y ) - {I}_{close\_obj} ( x , y )}{{I}_{open\_air} ( x , y ) - {I}_{close\_air} ( x , y )} / T ( x , y ) & ( 10 )\end{matrix}$$

The absorption image 24 shown in (E) in FIG. 6 is obtained by the aforementioned expression (9), and the dark field image 25 shown in (F) in FIG. 6 is obtained by the aforementioned expression (10).

(A) in FIG. 6 shows an image 20 captured in the state of the opened illumination by placing the object 3. (B) in FIG. 6 shows an image 21 captured in the state of the opened illumination without placing the object 3. (C) in FIG. 6 shows an image 22 captured in the state of the closed illumination by placing the object 3. (D) in FIG. 6 shows an image 23 captured in the state of the closed illumination without placing the object 3. Even in the case in which it is not possible to confirm cracks 9 existing inside of the absorption image 24, there is a case that it can be confirmed that cracks 9 exist inside of the dark field image 25.

### Effects of First Embodiments

In the first embodiment, the following effects can be obtained.

In the first embodiment, as described above, the X-ray phase imaging apparatus 100 is equipped with the X-ray source 1, the phase grating 2, the absorption grating 4, the detector 5, the image processing unit 6, the control unit 7, and the grating moving mechanism 8, and the phase grating 2 and the absorption grating 4 are placed at two predetermined positions, the state of the opened illumination and the state of the closed illumination. The image processing unit 6 generates an image including a dark field image (see (F) in FIG. 6) from the image captured with the object 3 placed and the image captured with the object 3 not placed in the state of the opened illumination and the closed illumination. Thereby, it is possible to suppress the number of times that an image is captured by moving (scanning) the phase grating 2 and the absorption grating 4 in the Y direction (in the direction orthogonal to the irradiation direction of the X-ray). As a result, the exposure time can be shortened and the exposure dose of the X-ray can be reduced.

In the first embodiment, as described above, the image processing unit 6 generates an image including a dark field image from images captured by placing the phase grating 2 and the absorption grating 4 in two relative positions of the opened illumination state and the closed illumination state. With this, by imaging at two predetermined positions in the state of the opened illumination and in the state of the closed illumination, since an image in which the dark field component and the absorption component are mixed can be extracted from the intensity difference of the X-ray obtained at two places, only the dark field image can be generated by removing the absorption component from the dark field component.

Further, in the first embodiment, as described above, the image processing unit 6 generates a dark field image from an image captured in the state of the opened illumination in which the center of the bright line 2c of the self-image of the phase grating 2 substantially coincides with the center of the slit 4a of the absorption grating 4, and in the state of the closed illumination in which the center of the bright line 2c of the self-image of the phase grating 2 substantially coincides with the center of the X-ray absorber 4b of the absorption grating 4. With this, it is possible to detect the X-ray of the portion corresponding to the vertex of the amplitude of the intensity-modulated signal obtained by detecting the X-ray. That is, since the intensity of the X-ray at the position most contributing to the contrast generation can be detected, the intensity difference of the obtained X-ray becomes maximum, and the decreased amount (the difference between W1 and W2 in FIG. 5) of the amplitude of the intensity-modulated signal with the object 3 placed becomes more clear. As a result, the accuracy of the generated dark field image (see (F) in FIG. 6) can be improved.

### Second Embodiment

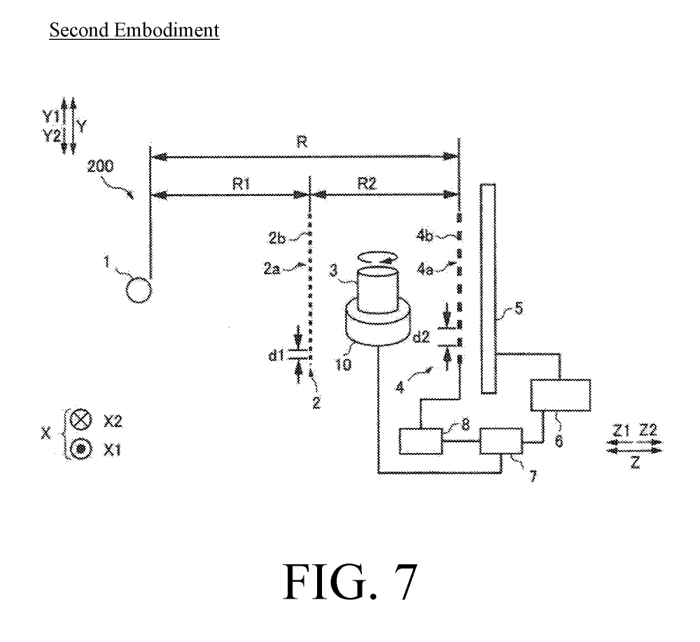

Next, an X-ray phase imaging apparatus 200 according to a second embodiment of the present invention will be described with reference to FIG. 7. Unlike the first embodiment configured to image the object 3 in the case in which the object 3 is fixed, in the second embodiment, it is configured to further include a rotation mechanism 10 for rotating the object 3 and perform CT imaging of the object 3. The same reference numerals are allotted to the same configurations as those of the first embodiment, and the description thereof will be omitted.

### (Configuration of X-Ray Phase Imaging Apparatus)

As shown in FIG. 7, the X-ray phase imaging apparatus 200 according to the second embodiment further includes a rotation mechanism 10 for rotating the object 3, and is configured to perform CT imaging of the object 3. More specifically, in the X-ray phase imaging apparatus 200, the control unit 7 is configured to perform CT imaging by imaging the phase grating 2 and the absorption grating 4 in the state of the opened illumination and the closed illumination while rotating the object 3 by 360 degrees via the rotation mechanism 10, in each of the rotation positions of a predetermined rotation angle (for example, 9 degrees).

Other configurations of the second embodiment are the same as those of the first embodiment.

### Effects of Second Embodiment

In the second embodiment, the following effects can be obtained.

In the second embodiment, as described above, the rotation mechanism 10 for rotating the object 3 is further provided, and an X-ray phase imaging apparatus 200 is configured such that CT imaging is performed by imaging the phase grating 2 and the absorption grating 4 in the state of the opened illumination and the closed illumination in each of a plurality of rotation positions accompanying the rotation of object 3. This makes it possible to suppress the number of times that an image is captured by moving (scanning) the grating in the Y direction at each rotation position of the object 3 at the time of performing CT imaging of the object 3, and it is possible to shorten the exposure time.

### Third Embodiment

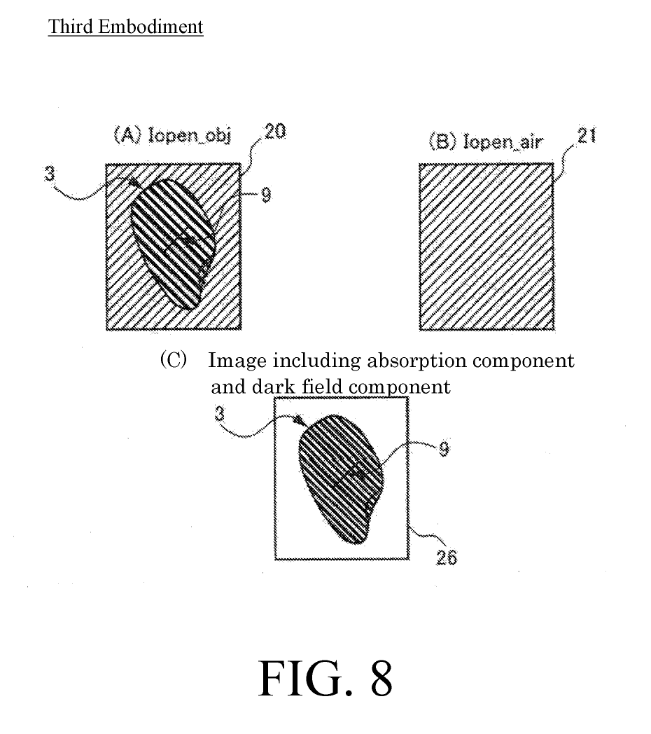

An X-ray phase imaging apparatus 300 according to a third embodiment of the present invention will be described with reference to FIGS. 2 and 8. In the third embodiment, unlike the first embodiment configured to generate a dark field image from an image captured by placing the phase grating 2 and the absorption grating 4 at two relative positions of the opened illumination and the closed illumination, it is configured to generate an image including an absorption image and a dark field image from an image captured by placing the phase grating 2 and the absorption grating 4 at one place in the state of the opened illumination. The same reference numerals are allotted to the same configurations as those of the first embodiment, and the description thereof will be omitted.

### (Configuration of X-Ray Phase Imaging Apparatus)

In the third embodiment, the X-ray phase imaging apparatus 300 is configured to generate an image including an absorption image and a dark field from the image captured in Step S2 and the image captured in Step S6 without performing Step S3 to Step S5, Step S7, and Step S8 of the flowchart shown in FIG. 2. That is, it is configured to generate an image 26 (see (C) in FIG. 8) including an absorption image and a dark field image from the image captured with the object 3 not placed (see (B) in FIG. 8) and the image captured with the object 3 placed (see (A) in FIG. 8) in the opened illumination state. More specifically, an image TD (x, y) including an absorption image and a dark field image is generated by the following expression (11).

$$TD ( x , y ) = \frac{{I}_{open\_obj} ( x , y )}{{I}_{open\_air} ( x , y )} \qquad ( 11 )$$

[86] Other configurations of the third embodiment are the same as those of the first embodiment.

### Effects of Third Embodiment

In the third embodiment, the following effects can be obtained.

In the third embodiment, it is configured to generate an image 26 including an absorption image and a dark field image from the image captured by placing the phase grating 2 and the absorption grating 4 at one place in the state of the opened illumination. With this, since the image 26 including the absorption image and the dark field image can be generated from the image captured at one predetermined position, it is possible to suppress the number of times of moving (scanning) of the grating in the Y direction. Further, in the case of using the medical use, the exposure dose of the X-ray can be reduced. Further, since the image 26 including the absorption image and the dark field image can be obtained at once, it is possible to generate the absorption image and the dark field image and save time and effort to synthesize.

Further, in the third embodiment, as described above, it is configured to generate an image 26 including an absorption image and a dark field image from the image that captured the phase grating 2 and the absorption grating 4 are captured in the state of the opened illumination. With this, since it is possible to detect the X-ray of the portion corresponding to the vertex of the amplitude of the intensity-modulated signal obtained by detecting the X-ray, the changed amount of the amplitude of the intensity-modulated signal between the case in which there exists an object 3 and in the case in which there exists no object becomes maximum, and the way of decreasing the amplitude of the intensity-modulated signal in the case in which there exists an object 3 becomes more clear. As a result, the accuracy of the generated image 26 (see (C) in FIG. 8) can be improved.

### Fourth Embodiment

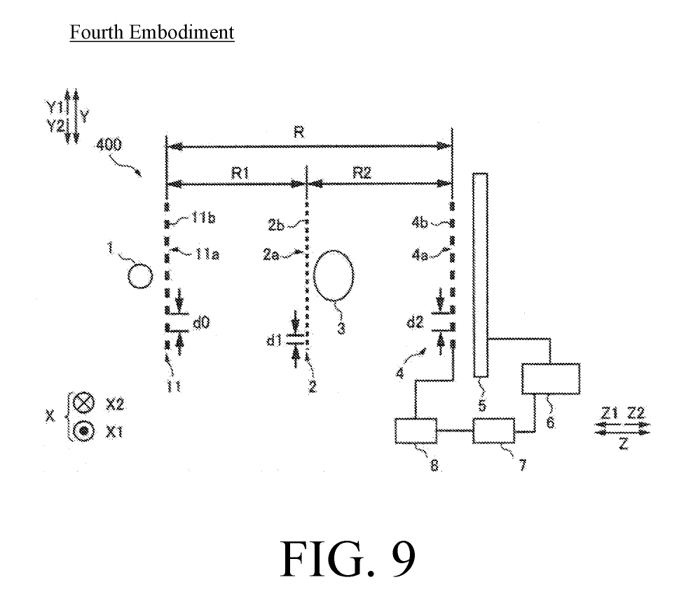

Next, an X-ray phase imaging apparatus 400 according to a fourth embodiment of the present invention will be described with reference to FIG. 9. In the fourth embodiment, in addition to the configuration of the first embodiment, it is configured to further include a multi slit 11 between the X-ray source 1 and the phase grating 2. The same reference numerals are allotted to the same configurations as those of the first embodiment, and the description thereof will be omitted.

### (Configuration of X-ray Phase Imaging Apparatus)

In the fourth embodiment, as shown in FIG. 9, the X-ray phase imaging apparatus 400 further includes a multi slit 11 arranged between the X-ray source 1 and the phase grating 2. The multi slit 11 is an example of the “third grating” recited in claims.

The multi slit 11 has a plurality of slits 11a and X-ray absorbers 11b arranged at a predetermined period (pitch) d0 in the Y direction. The slit 11a and the X-ray absorber 11b are each configured so as to extend in the X direction.

The multi slit 11 is arranged between the X-ray source 1 and the phase grating 2, so that an X-ray is irradiated from the X-ray source 1. The multi slit 11 is configured so that the X-ray that passed through each slit 11a is a line light source corresponding to the position of each slit 11a. With this, the multi slit 11 can increase the coherence of the X-ray irradiated from the X-ray source 1.

When the distance between the multi slit 11 and the phase grating 2 is R1, the distance between the phase grating 2 and the absorption grating 4 is R2, and the distance between the X-ray source 1 and the absorption grating 4 is R, the positional relationship between the multi slit 11, the phase grating 2, and the absorption grating 4 is expressed by the following expression (12).

$${d}_{0} = \frac{{R}_{1}}{{R}_{2}} {d}_{2} = \frac{R}{{R}_{2}} {d}_{1} \qquad ( 12 )$$

Other configurations of the fourth embodiment are the same as those of the first embodiment.

### Effects of Fourth Embodiment

In the fourth embodiment, the following effects can be obtained.

In the fourth embodiment, a multi slit 11 arranged between the X-ray source 1 and the phase grating 2 is further included. With this, the coherence of the X-ray irradiated from the X-ray source 1 can be increased, so even if the focal length of the X-ray source 1 is not very small, an image including a dark field image can be generated.

### Modified Embodiment

It should be understood that the embodiments disclosed here are examples in all respects and are not restrictive. The scope of the present invention is shown by the scope of the claims rather than the descriptions of the embodiments described above, and includes all changes (modifications) within the meaning of equivalent and the scope of claims.

For example, in the first embodiment, an example is described in which an image including a dark field image is generated from an image captured in the state of the opened illumination in which the center of the bright line 2c of the self-image of the phase grating 2 substantially coincides with the center of the slit 4a of the absorption grating 4 and an image captured in the state of the closed illumination in which the center of the bright line 2c of the self-image of the phase grating 2 substantially coincides with the center of the X-ray absorber 4b of the absorption grating 4. However, the present invention is not limited to this. For example, since the dark field image cannot be generated in the X-ray detected at the same location in which the intensity of the X-ray obtained by the detector 5 is the same, it is configured to generate an image including a dark field image from the image captured by placing the phase grating 2 and absorption grating 4 so that the intensity of the detected X-ray differs.

Further, for example, it may be configured to generate an image including a dark field image from an image captured in the relative position where the center of the bright line 2c of the self-image of the phase grating 2 is located at a position other than the center of the slit 4a of the absorption grating 4, and an image captured in the relative position where the center of the bright line 2c of the self-image of the phase grating 2 is located outside the center of the X-ray absorber 4b of the absorption grating 4.

Further, in the second embodiment, an example is shown in which the object 3 is rotated to perform CT imaging, but the present invention is not limited thereto. For example, it may be configured to perform CT imaging by rotating an imaging system including the X-ray source 1, the phase grating 2, the absorption grating 4, and the detector 5.

Further, in the second embodiment, in each rotation position of the object 3, an example is described in which CT imaging is performed by capturing the phase grating 2 and absorption grating 4 in the state of the opened illumination and the closed illumination, but the present invention is not limited thereto. For example, in each of a plurality of rotation positions accompanying the relative rotation of one rotation of the object 3 and the imaging system, it may be configured that the image processing unit 6 performs tomographic imaging by capturing the image by arranging the phase grating 2 and the absorption grating 4 in either the opened illumination or the closed illumination in the range of 180 degrees in the first half, and by capturing the image by arranging the phase grating 2 and the absorption grating 4 in the other of the opened illumination or the closed illumination in the range of 180 degrees in the second half. By configuring as described above, in each rotation position, during imaging within the range of 180 degrees in the first half and during imaging within the range of 180 degrees in the second half, CT imaging (tomography) can be performed without moving (scanning) the grating in the periodic direction of the grating. In other words, during the image capturing in the range of 180 degrees in the first half, imaging is performed in either the opened illumination state or the closed illumination state, during the image capturing in the range of 180 degrees in the latter half, imaging is performed in the other state of the opened illumination or the closed illumination. Therefore, at each rotation position other than 180 degrees, CT imaging (tomography) can be performed without switching between the opened illumination and the closed illumination every time. As a result, compared with CT imaging (tomography) using a normal fringe scanning method, it becomes possible to further reduce the number of times that an image is captured by moving (scanning) the grating in the periodic direction of the grating, so that the exposure time can be further shortened.

In the third embodiment, an example is described in which an image including the absorption image and the dark field image from the image captured in the state of the opened illumination in which the center of the bright line 2c of the self-image of the phase grating 2 substantially coincides with the center of the slit 4a of the absorption grating 4, but the present invention is not limited to this example. For example, it may be configured to generate an image including an absorption image and a dark field image from an image captured at a relative position where the center of the bright line 2c of the self-image of the phase grating 2 is located at a position other than the center of the slit 4a of the absorption grating 4.

Further, in the third embodiment, an example is described in which the image 26 including an absorption image and a dark field image is generated from the image captured the phase grating 2 and absorption grating 4 in the opened illumination state, but the present invention is not limited thereto. For example, it may be configured to generate an image including an absorption image and a dark field image from an image that captured the phase grating 2 and the absorption grating 4 in a closed illumination state.

Further, in the first to fourth embodiments, an example is described in which the imaging is performed by moving the absorption grating 4 in the Y direction with the grating moving mechanism 8, but the present invention is not limited thereto. For example, the grating moving mechanism 8 may be configured to image the phase grating 2 by moving the phase grating 2 in the Y direction. Further, it may be configured to perform imaging by moving the multi slit 11 in the Y direction by the grating moving mechanism 8.

Further, in the first and second embodiments, although an example is described in which the phase grating 2 is provided to form the self-image by a Talbot effect, the present invention is not limited to this. Since it is enough that the self-image of phase grating 2 has a striped pattern, instead of the phase grating 2, absorption grating may be used to use the shadow of absorption grating as a self-image striped pattern. In this case, the present invention can also be applied to a non-interferometer which does not use Talbot interference.

Further, in the first embodiment, an example is described in which the control unit 7 moves the grating in the order of Steps S1 to S9 to capture an image, but the present invention is not limited thereto. For example, the control unit 7 may be configured to perform image capturing in the order of Steps S5 to S8, S1 to S4, and S9. In addition, when Steps S1 and S2, Steps S3 and S4, Steps S5 and S6, and Steps S7 and S8 are respectively set, the order of each set may be switched and image capturing may be performed.

1. An X-ray phase imaging apparatus comprising:
an X-ray source;
a detector configured to detect an X-ray irradiated from the X-ray source;
a plurality of gratings including a first grating to which the X-ray is irradiated from the X-ray source and a second grating to which the X-ray that passed through the first grating is irradiated, the first grating and the second grating being arranged between the X-ray source and the detector; and
an image processing unit configured to generate an image including a dark field image from an intensity distribution of the X-ray detected by the detector,
wherein the image processing unit generates the image including the dark field image from an image captured by placing the plurality of gratings at one or two predetermined positions.

2. The X-ray phase imaging apparatus as recited in claim 1,
wherein the image processing unit generates the dark field image from an image captured at two positions of a first relative position and a second relative position in which one of the plurality of gratings is moved in a periodic direction of the grating.

3. The X-ray phase imaging apparatus as recited in claim 2,
wherein the image processing unit is configured to generate the dark field image from a first image captured at the first relative position where the first grating and the second grating are arranged so that a center of a bright line of a self-image of the first grating is located at a slit portion of the second grating, and a second image captured at the second relative position where the first grating and the second grating are arranged such that the center of the bright line of the self-image of the first grating is located at an X-ray absorption portion of the second grating.

4. The X-ray phase imaging apparatus as recited in claim 3,
wherein the image processing unit is configured to generate the dark field image from the first image captured at the first relative position where the first grating and the second grating are arranged so that the center of the bright line of the self-image of the first grating substantially coincides with a center of the slit portion of the second grating, and the second image captured at the second relative position where the first grating and the second grating are arranged such that the center of the bright line of the self-image of the first grating substantially coincides with the center of the X-ray absorption portion of the second grating.

5. The X-ray phase imaging apparatus as recited in claim 2, further comprising a rotation mechanism configured to relatively rotate an imaging system and the object, the imaging system including the X-ray source, the plurality of gratings, and the detection unit, in each of a plurality of rotation positions accompanying a relative rotation between the object and the imaging system, tomographic imaging is performed by placing a plurality of gratings at the first relative position and the second relative position.

6. The X-ray phase imaging apparatus as recited in claim 2, further comprising a rotation mechanism configured to relatively rotate an imaging system and the object, the imaging system including the X-ray source, the plurality of gratings, and the detection unit,
wherein the image processing unit performs tomographic imaging, in each of a plurality of rotation positions with the relative rotation of one rotation of the object and the imaging system, by capturing an image by placing the plurality of gratings in either the first relative position or the second relative position in a range of 180 degrees in a first half, or by capturing an image by placing the plurality of gratings in either the first relative position or the second relative position in a range of 180 degrees in a second half.

7. The X-ray phase imaging apparatus as recited in claim 1,
wherein the image processing unit generates a third image including an absorption image and the dark field image from an image captured by placing the plurality of gratings at one predetermined position.

8. The X-ray phase imaging apparatus as recited in claim 7,
wherein the image processing unit generates the third image from either one of the first image captured by placing the first grating and the second grating so that a center of a bright line of the self-image of the first grating substantially coincides with a center of a slit portion of the second grating, and the second image captured by placing the first grating and the second grating so that the center of the bright line of the self-image of the first grating substantially coincides with a center of an X-ray absorption portion of the second grating.

9. The X-ray phase imaging apparatus as recited in claim 8,
wherein the image processing unit is configured to generate the third image from either one of the first image captured by placing the first grating and the second grating so that the center of the bright line of the self-image of the first grating substantially coincides with the center of the slit portion of the second grating, and the second image captured by placing the first grating and the second grating so that the center of the bright line of the self-image of the first grating substantially coincides with the center of the absorption portion of the second grating.

10. The X-ray phase imaging apparatus as recited in claim 1,
wherein the plurality of gratings further includes a third grating placed between the X-ray source and the first grating.
